(19) United States
(12) Patent Application Publication
(10) Pub. No.: US 2009/0177481 A1
(43) Pub. Date: Jul. 9, 2009

(54) Method and system of wireless quality for fee

(75) Inventor: Michael Thomas Curtin, Melbourne, FL (US)

Correspondence Address: Bruce B. Brunda, Suite 250, 75 Enterprise, Aliso Viejo, CA, 92656, US

(73) Assignee: Northrop Grumman Corporation

(21) Appl. No.: 12/006,631

(22) Filed: Jan. 4, 2008

(51) Int. Cl. G06Q 30/00

(52) U.S. Cl. 705/1

(57) ABSTRACT

A method of selecting and receiving enhanced wireless service is provided in association with a wireless device. The method comprises designating at least one device number to receive a communication; selecting at least one feature of the enhanced wireless service and receiving the selected at least one feature in connection with the communication. The method may be provided in connection with different types of communications including voice, text, video and picture data. The enhanced wireless service may be automatically provided in connection with a service contract or the enhanced wireless service may be selected for each outgoing or incoming communication.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The invention relates to a method and system for the user-initiated and fee-based selection and receipt of enhanced wireless service.

Wireless communications service, often interchangeably used with the terms cellular and mobile service, generally dates back to the 1940s. The first cellular telephones were so large that the telephones were permanently installed as part of a vehicle. In addition, very few service providers existed, and the service was not particularly reliable, as many geographic areas had little to no coverage. Thus, individuals have traditionally relied on a landline to address their telecommunication needs. In fact, many individuals continue to maintain a landline in addition to subscribing to a wireless service. However, over the last ten years, wireless devices have become an integral part of daily life both personally and professionally. Many users now rely on their wireless device as their sole source of telecommunications contact with others. Wireless devices have been miniaturized and further have the capability to support many other features in addition to the standard functions of a telephone. These features include personal calendaring, web browsing, electronic mail and text and picture messaging. Wireless device usage further continues to increase at a rapid rate as the functionality of the available devices is expanded. Moreover, new devices that support unique features are emerging as networks are upgraded and services becomes more reliable.

As previously noted, only a few service providers initially existed in each geographic area. As the market for wireless service grew over both time and geographic area, additional wireless service providers began to provide service with some offering plans on a nationwide basis. Each service provider typically offers a variety of service plans to fit the lifestyle, budget and/or needs of the user. Although wireless device users tend to focus mainly on price when comparing and selecting a service provider and choosing between available service plans, quality of the service should be the primary and most important overall purchase criterion. For example, each service provider typically promises the highest quality over a range of service plans which are generally priced over a range of costs that may further correlate to a variety of coverage areas or allotted free airtime minutes. Further, wireless service providers offer service contracts that may be renewable on a periodic basis, such as monthly or yearly, in addition to pay-as-you-go or other pre-paid service plans. Generally, the only differences between the service plans that are available from a service provider are commitment and price. Regardless of whether a user subscribes to a contract plan or a pay-as-you-go plan, the quality of service is generally intended to be equal for all subscribers of a wireless service.

The increase in wireless device usage has caused subscribing users to demand coverage from their service providers anytime and anywhere. Inexpensive wireless service often comes with a built-in price of its own, as lower cost tends to equate to lower voice quality, greater likelihood of dropped communications and decreased range of service. Each wireless service provider utilizes a complex network technology to provide its services. Often the network structure, or the manner in which the structure is utilized, contributes to the poor quality of the service overall or within a certain geographic area of the network, especially in the case of less established wireless service providers. Inferior wireless service can be frustrating and expensive because the user is paying for a convenience that he cannot use on a consistent basis. Thus, a large percentage of wireless device users change their service provider frequently in search of more reliable service because the current service simply fails to work when the user wants or needs to use it.

Modifications should be made to the manner in which wireless service is provided by a service provider to its users such that better quality of service can be offered to a wireless subscriber. However, wireless service providers are challenged with finding a cost-effective way to provide such enhanced service to their subscribers. For example, the cost of replacing network equipment may outweigh the potential return if the current equipment is still working properly. What is lacking in the art is a methodology by which a user can elect to receive a better quality of wireless service from his or her service provider within the wireless network. The methodology should be easily incorporated into any particular service provider's network so that the wireless service provider can provide enhanced quality to its subscribers in a cost-effective manner.

### BRIEF SUMMARY

A method of selecting and receiving enhanced wireless service is provided to be utilized in association with a wireless device. In one embodiment, the user may subscribe to a contract that includes enhanced wireless service. In such case, the method of selecting and receiving the enhanced wireless service may include the steps of subscribing to at least one feature of the enhanced wireless service and automatically receiving the at least one feature of the enhanced wireless service for each communication associated with the wireless device. In another embodiment, the user may select the enhanced wireless service on a per communication basis. In such case, the method of selecting and receiving enhanced wireless service may include the steps of designating at least one device number to receive a communication; selecting at least one feature of the enhanced service; and receiving the selected at least one feature of the enhanced service in connection with the communication. The enhanced wireless service may be utilized in connection with various types of communications including voice, text, video and picture data.

In one embodiment, the method of selecting and receiving enhanced wireless service may further comprise the step of receiving a prompt to select the at least one feature of the enhanced service. The prompt may be a verbal prompt or the prompt may be in the form of an applet that may be initiated when the user wants to select the enhanced wireless service. A response to the prompt may be provided by depressing a key or a combination of keys on the wireless device. If the user does not subscribe to a contract that includes the enhanced service, the method of selecting and receiving enhanced wireless service may further include receiving a prompt to select a method of payment for the selected at least one feature of the enhanced service. The method of payment may be a monetary value or the allotment of additional airtime minutes to the communication or any monetary equivalent, which may include customer earned loyalty minutes or rollover minutes that can be converted to premium quality minutes.

The enhanced wireless service may be selected for an outgoing communication, an incoming communication or during a communication. Selection of the enhanced wireless service may require a form of input by the user, which may include a verbal command; the manipulation of a dedicated key on the device that specifically functions to allow the user to select the enhanced wireless service; the manipulation of a key on the device that toggles between at least two functions, one of which includes the selection of the enhanced wireless service; or the selection and/or depression of a combination of keys, such as *50, on the keypad of the device.

A method of providing enhanced wireless service is also provided. In one embodiment, a service provider may provide the enhanced service automatically to a user that subscribes to a plan that includes the enhanced wireless service. In such a case, the method of providing enhanced wireless service includes receiving a communication from a wireless device and automatically providing at least one feature of the enhanced wireless service for each communication associated with the wireless device. In another embodiment, a service provider may provide the enhanced wireless service to a user that selects the enhanced wireless service on a per communication basis. In such case, the method of providing enhanced wireless service includes the steps of receiving a communication from a wireless device; verifying the validity of an account associated with the wireless device; providing a prompt to select at least one feature of the enhanced service; receiving input from the wireless device in response to the prompt; and transmitting the communication from the wireless device in association with the input received from the wireless device.

The method of providing enhanced wireless service may further include the step of providing a prompt to the wireless device for selecting a method of payment for the selected at least one feature of the enhanced service and receiving input from the wireless device in response to the prompt. The method of providing enhanced wireless service may further include the step of regulating the operation of the device in response to the input received from the wireless device.

The device may be regulated by increasing the number of bits exchanged between the device and a base station located near the device; by increasing the number of allocated time slots to the device; by increasing the bandwidth provided to the device; or by increasing the number of codes provided to the device.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a representation of a typical wireless service network in which the methodology of the present invention may be used to provide an enhanced wireless service to a user.

FIG. 2 is a representation of a user register indicating whether or not a user has selected an enhanced wireless service plan.

FIG. 3 is a flow chart representing one implementation of a user-initiated service for selecting an enhanced service from the perspective of a wireless user.

FIG. 4 is a flow chart representing a second implementation of FIG. 3 from the perspective of the service provider.

FIG. 5 is a diagrammatic representation of one embodiment of a message containing data to direct the implementation of the enhanced service for a particular user.

FIG. 6 is an exemplary embodiment of a user interface for selecting features of the enhanced service.

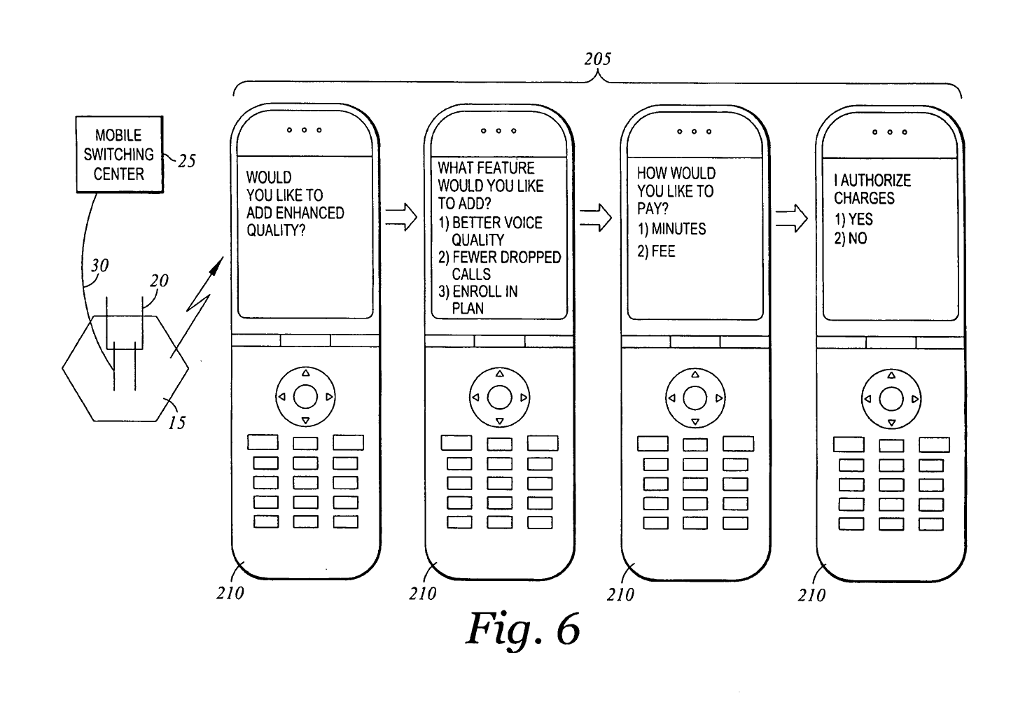

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are intended to be encompassed within the scope of the invention.

The invention is directed to a user-initiated service in which the user selects and receives enhanced wireless service. The enhanced wireless service may be a more reliable service that may include, without limitation, features such as increased signal strength and improved voice quality. The enhanced service may be provided in connection with communications that are transmitted over a wireless network, including but not limited to voice, text, video and photos. The user may also cause the service to be selected at the commencement of the communication, whether incoming or outgoing, or at any time during the communication. The service provider may require the user to pay an additional fee to utilize the enhanced service. For example, the user may pay on a per communication basis, such as upon the initiation, the receipt or during the communication. Alternatively, the user may subscribe to an enhanced service plan provided by the service provider with the fee being charged on a weekly, monthly or yearly basis, such as in association with a service contract. When the user is enrolling in a new service contract or renewing an existing contract, the user may elect to enroll in an enhanced service plan if it is offered by the service provider. Enrollment in an enhanced service plan may result in a higher monthly charge paid by the user, which is associated with the enhanced service. Further, the service provider may provide options for the user such that the user may pay a fee for a set number of communications to be sent or received in accordance with the enhanced service plan. As further described herein, if the user does not enroll in an enhanced service plan, the user may elect to pay a monetary charge for the service on a per-communication basis. Alternatively, a user that is paying for the service on a per communication basis may have the option of allotting additional minutes to each individual communication for which the enhanced service is desired.

An exemplary subscriber to an enhanced service plan may be a corporate executive who spends a significant amount of time on his or her wireless device, perhaps engaging in conference calls or performing other important tasks utilizing his or her wireless device. The corporate executive may require better voice quality and fewer dropped calls due to the nature of his business or employment and the purpose of his communications. Such a user would likely be interested in a service contract that includes the enhanced service throughout the term of the contract. Another example may be a particular user who is anticipating a life event, such as the birth of a child, and the user naturally requires service that is as reliable as possible. However, the user may only want to keep the service under a short term contract. Similarly, a pay-as-you go user may only have occasional use for the enhanced service. For example, a user may communicate with distant family members on holidays and special occasions and possibly irregularly throughout the month. The user may only want to utilize the enhanced service for these infrequent communications.

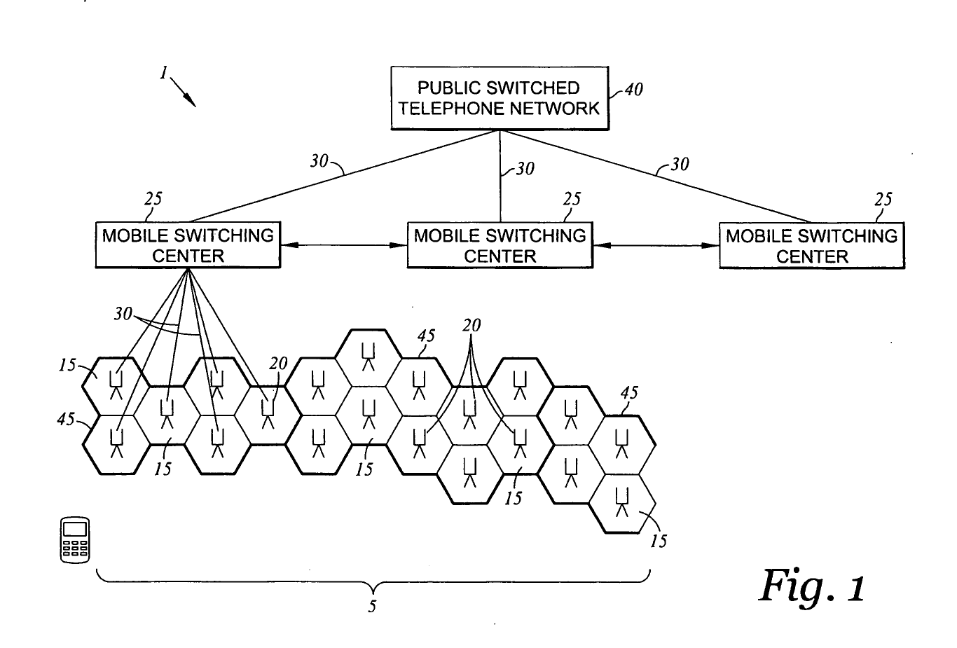

FIG. 1 represents a typical wireless service network 1 which covers a geographic area 5 that is divided into a plurality of cells 15. Each cell 15 comprises a base station 20 which may further comprise a tower and any associated equipment such as a radio transmitter/receiver. A wireless service network 1 generally requires a large number of cells 15 and associated base stations 20. The cells 15 may scale in number and size with the geographic area 5 covered by the wireless network. Each cell 15 is typically several kilometers in diameter, and each base station 20 typically services only one individual cell 15. A plurality of cells 15 are grouped together to form a cluster 45, and each base station 20 within a single cluster 45 is further connected to a mobile switching center 25 by a landline 30.

The mobile switching center 25 is an important element of a wireless service network 1 because the mobile switching center 25 connects a path from a wireless user 35 to the other party of the communication for each incoming and outgoing communication. Specifically, the mobile switching center 25 is responsible for directing communications to each user 35 located within a particular cell 15 by handling all of the service connections to and from the normal land-based telephone system. The mobile switching center 25 provides a path to the public switched telephone network 40, which delivers calls to and from land-based telephones or to long-distance numbers.

The mobile switching center 25 further controls all of the base stations 20 in the cluster 45. As the user 35 moves around the network and changes geographic location, the user may also move or migrate between cells 15. The mobile switching center 25 is responsible for reconnecting a communication in progress to a base station 20 in a new cell 15, if necessary, in a procedure often referred to as hand-off. Each cell 15 is assigned a transmission power and certain radio frequencies, as further described herein. By controlling the transmission power and the radio frequencies assigned to each cell 15, a computer at the mobile switching center 25 can monitor and direct the movement of the wireless device from one cell 15 to another cell 15.

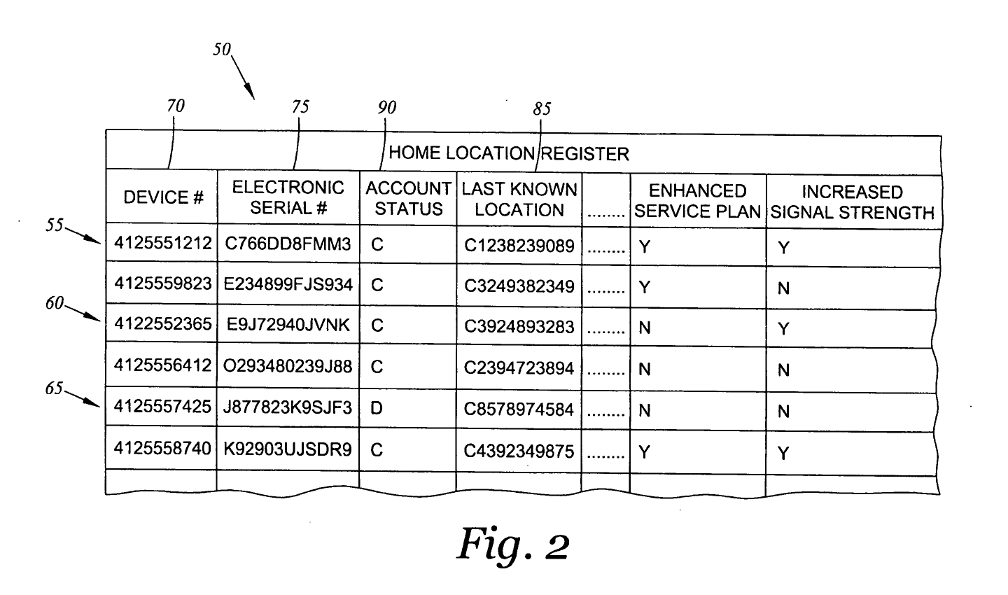

As shown in FIG. 1, there can be many mobile switching centers 25 in a wireless service network 1. Each mobile switching center 25 that is associated with a cluster 45 of cells 15 is further connected to other mobile switching centers 25 of other clusters 45 of cells 15 and also to the public switched telephone network 40. Each service provider generally has at least one mobile switching center 25 in each city and the mobile switching center 25 stores information about each user that subscribes to its service in a user register 50, as further described with respect to FIG. 2. The user register is an integral component of a wireless network, and as shown herein, the information contained therein is used for call control and processing.

Referring to FIG. 2, an exemplary user register 50 is shown. The user register 50 is a database that is maintained and continuously updated by the mobile switching center 25. The user register 50 includes all of the information associated with a subscribing user's wireless device and service plan. The user register 50 may include such information as service plan data, last known location and billing information. For example, the user register 50 maintains the electronic serial number 75 of the mobile phone, the device number 70, the particular calling plan and any additional calling plan features the customer has, including without limitation, call forwarding, call waiting, three-way calling and voice mail. Additionally, information regarding the last known location 85 of the wireless device is stored in the user register 50. The user's wireless device communicates periodically with the mobile switching center 25 regarding its then-current location. This updated information is stored in the user register 50 as the last known location 85 so that communications may be routed to the base station 20 that correlates to the general location of the wireless device. Finally, the user register 50 also contains information regarding any dialing restrictions in addition to billing information, such as account status 90, for account validation. Thus, if a user's account is not current for billing purposes, the mobile switching center 25 can block incoming and outgoing communications to and from the subscribing user's wireless device.

Wireless service providers almost inevitably receive complaints from subscribing users regarding service issues, including decreased signal strength, which may result in dropped communications, decreased range of service and poor voice quality. A dropped, or lost, communication generally refers to an active wireless telephone call that is terminated unexpectedly as a result of any one or more of a variety of technical or other reasons. For example, an active wireless communication may be dropped when the wireless device moves out of range of the network. Sometimes, an active communication is not maintained across a different service provider's network which may result in the termination of the communication once the signal is lost between the wireless device and the original service provider's network.

An active communication may also be dropped when the wireless device enters an area where wireless communication is not available, interrupted, interfered with or jammed. The lost communication is similar to when the wireless device moves out of range of the network coverage area. Occasionally, an active communication may be dropped when it is transferred between cells within the same service provider's network due to an imbalance of traffic between the two cells' areas of coverage. If the new cell is at capacity or if the other cell is unaware of the origination or the potential destination cell, the new cell may be unable to accept the additional traffic of the communication. If an alternative cell is unavailable, the communication may be dropped. Channel interference may also be responsible for dropped communications in a wireless network. For example, a neighboring cell with the same frequency may interfere with an adjacent cell which deteriorates the quality of service and produces dropped communications.

Service providers have attempted to address these issues and other complaints mainly by compensating its subscribing users. Dropped communications are sometimes addressed in the form of monetary compensation by providing refunds for the dropped calls or the service provider may offer additional plan minutes for the month or even credit a certain amount of used minutes back to the user. However, the described manner of addressing service issues only compensates the user for the problem as it is happening. Compensating the user does not provide a solution to prevent future service issues by addressing the problem at its cause.

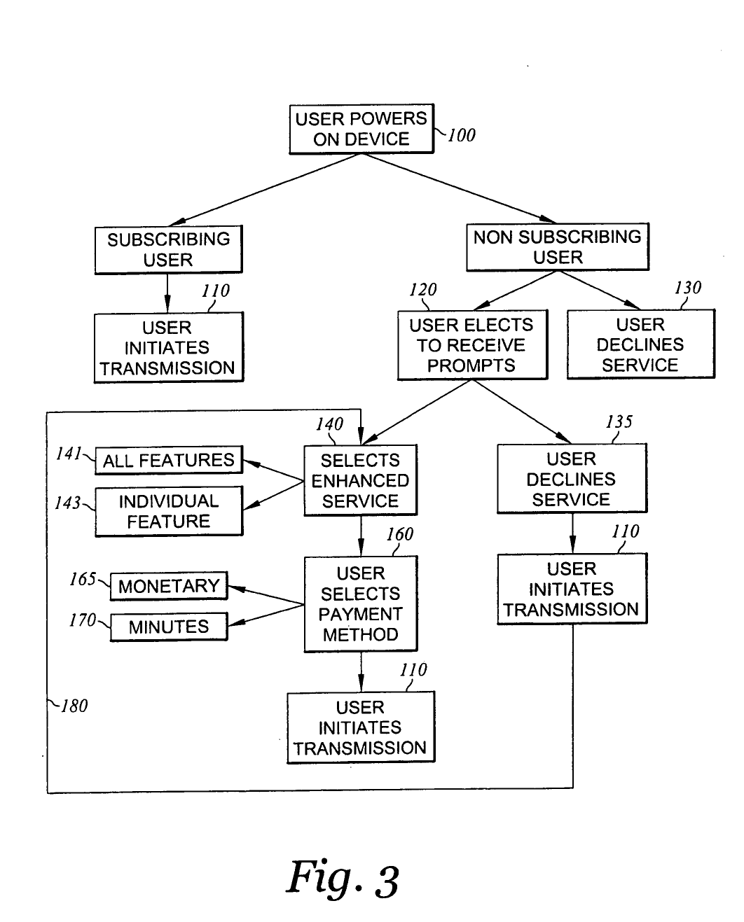

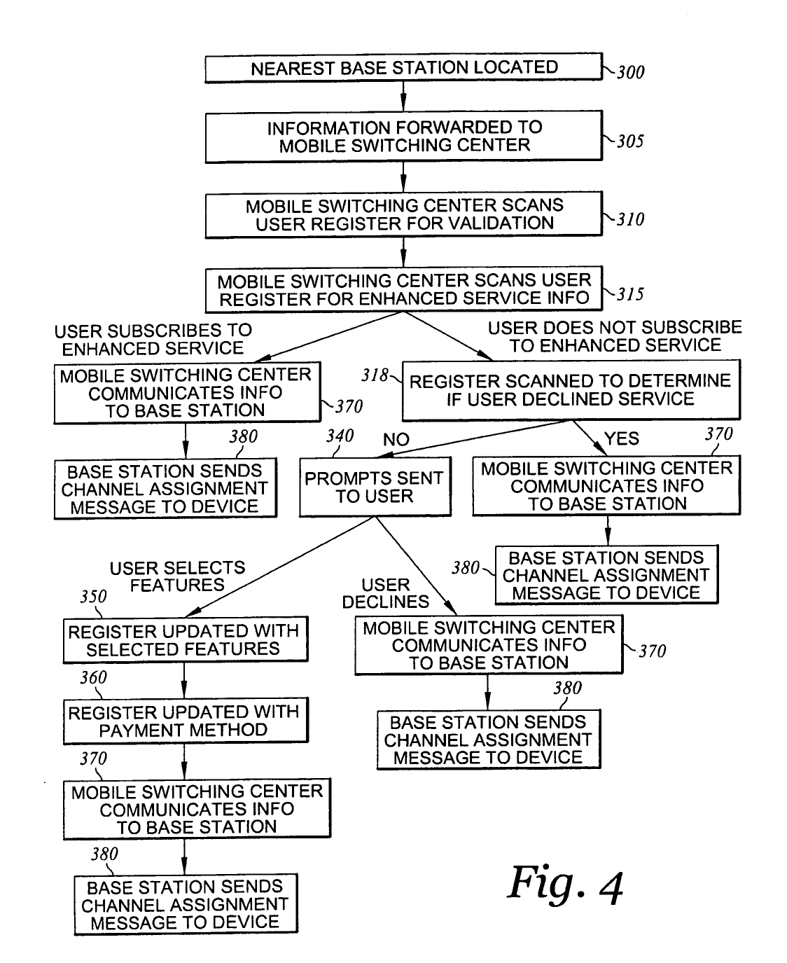

FIGS. 3 and 4 represent the methodology by which a wireless subscriber who desires enhanced service can elect to receive such service. The methodology may require a form of input provided by the user. The input may be verbal such as by speaking commands into the wireless device or the input may be provided by depressing a designated key or combination of designated keys on the keypad of the wireless device. For example, the user may press a combination of the keys *50 to initiate the receipt of the enhanced service. The wireless device may also be adapted to include a dedicated key, which may be depressed or otherwise manipulated, to cause the automatic application of any or all of the features of the enhanced service to the communication. Prompts for such input may be generated by the mobile switching center and communicated to the user at the initiation of an outgoing or incoming communication the call or the user may provide input during the communication to cause application of any or all of the features. The subscriber may further elect to receive the enhanced service on a contract basis so that each communication is automatically and continually placed using the enhanced service features. Alternatively, the service provider may offer the enhanced service on a per communication basis. The enhanced service can be utilized by the service provider as a method of addressing service issues in a technical manner in which the cost is passed on to the users of the enhanced service.

For example, using the described methodology the service provider may provide an enhanced service that would reduce the number of dropped calls, such as by causing a greater amount of power to be transmitted from the base tower to the wireless device. By increasing the power transmitted from the base station to a user's wireless device, the device may be able to maintain an appropriate signal strength where it would normally be adversely affected by terrain or building and structures. Similarly, the service provider may be able to address voice quality issues by increasing the number of bits exchanged between the device and the base station. This may be accomplished for example, by increasing the number of time slots allocated; by providing more bandwidth to a communication or by modifying the encoding mechanism that converts the user's voice into a digitized signal or any other known upgrade that would provide better quality.

Two types of wireless standards are mainly used by service providers. The first is Time Division Multiple Access, or TDMA, which is similar to and utilized in another common wireless standard, Global Systems for Mobile Communications, or GSM and the second is Code Division Multiple Access, or CDMA.

Specifically, TDMA is a channel access method for shared medium networks. It allows several users to share the same frequency channel by dividing the signal into different time slots. The users transmit in rapid succession, one after the other, with each user utilizing his own assigned time slot. CDMA is a form of multiplexing and a method of multiple access that does not divide up the channel by time, such as in TDMA, or by frequency, such as with older wireless standards. Instead, CDMA encodes data with a special code associated with each channel and uses the constructive interference properties of the special codes to perform the multiplexing. CDMA-based wireless devices utilize a digital modulation code to spread the energy of the transmitted signal in a pseudo-random fashion over a wider frequency bandwidth. Each transmitting user is assigned a unique code within a local network and the receiver is provided with the code of the transmitter. The receiver unscrambles the random transmission and reassembles the voice data.

Minor adaptations may be made to the existing network architecture associated with TDMA, CDMA or almost any other wireless standard technology so that the methodology of providing enhanced service may be used therewith. In a TDMA-based network, improved quality may be achieved by assigning twice as many time slots to a communication. The additional time slots may be used to (a) encode the voice data using half-rate forward error correction to improve the performance at the receiver; (b) reduce the voice data rate by a factor of two to increase the energy per transmitted bit and thereby improve the performance at the receiver, or (c) provide temporal diversity by repeating the voice data. In a CDMA-based network, improved quality may be achieved within the existing architecture of the network if a communication is assigned twice as many codes. The additional codes may be used to (a) encode the voice data using a half-rate forward error correction to improve the performance at the receiver; (b) reduce the voice data rate by a factor of two to increase the energy per transmitted bit and thereby improve the performance at the receiver or (c) provide code diversity by repeating the voice data.

It should be noted that although additional time slots or codes may be assigned to a wireless user, such additional time slots or codes do not necessarily equate to the creation of new time slots or codes within the frequency or channel, as the creation of these additional time slots or codes may lead to decreased quality. A certain amount of power is received from the transmitter and the addition of more time slots or codes to the existing number of the same would unnecessarily divide the available power to the detriment of the wireless service, as it currently exists. Thus, in one embodiment, existing time slots or codes may be combined to create a common time slot or common code. Combining at least two codes or two time slots to form a single code or single time slot, respectively, results in an increased amount of data that may be transmitted at one time as the assignment of the combined code or time slot results in the occupation of more bandwidth by the communication.

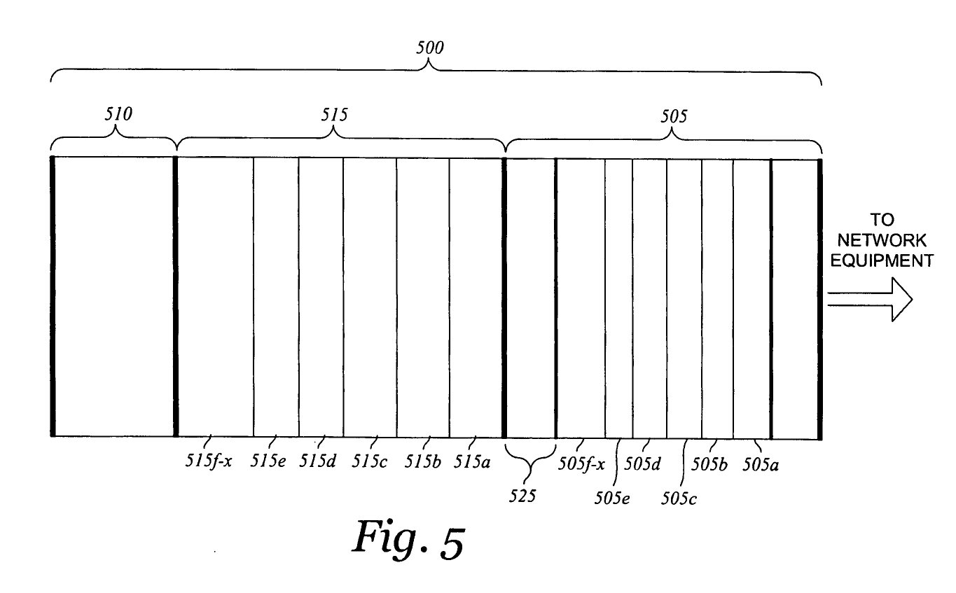

In order for a wireless device to utilize additional codes or time slots for the transmission of a wireless communication or utilize a combined code or time slot, the wireless device must be capable of sending and receiving data in such a manner that the communication may be directed to occupy more than one code. This may be accomplished by modifying the manner in which the messages containing the communication are addressed and transmitted. For example, during a wireless communication using CDMA technology, signals from different users are distinguished by unique code sequences. Further, each transmission is broken up into smaller packets of data, and each packet of data is given an identifying code. At the receiving end, the receiving device has knowledge of the code sequence being sent which allows the data to be extracted and reconstructed so that the pieces of each communication may be isolated and reassembled. In one embodiment, instructions to the network equipment, such as the base tower or the mobile switching center, regarding the assignment of additional codes or time slots or the direction to combine codes or time slots may be included in each packet that is transmitted during a wireless communication. For example, the instructions may be included within the header 505 of the packet 500, such as within the control bits or the reserve bits of a header 505, as further described with respect to FIG. 5.

Referring to FIG. 5, a packet 500 of data is shown carrying communication data 515 for an exemplary number of users. Information regarding the processing of a communication may be provided to the base tower through the packet 500, which is a typical structure used to send data over a network. Packets 500 vary greatly as between technologies in how they are used but only differ primarily in terms of their content. Every protocol utilizes a special formatting method for the structure of packets 500, however, each packet 500 is fairly uniform in overall structure and contains three elements.

First, the packet 500 contains a header 505 which is the information that is placed before the actual data 515 of the communication. The header 505 serves as the communication and control link between protocol elements to direct the data 515 and provide instructions to equipment as to signaling and other transmission issues. Generally, the header 505 contains a number of control information bits which are used to synchronize packets 500 communicated within the network and communicate important information about the data 515 contained within the packet 500, such as how it is to be interpreted and used. The header 505 may also contain information that identifies the user associated data 515 or, with regard to the enhanced wireless service, identifies the quality of service associated with the users, if applicable.

A typical header 505 contains information regarding the length of the packet 500 such as the total number of bits (although some networks may have fixed length packets while others rely on the header for such information); synchronization information which may consist of a bits that assist in matching the packet 500 with the network; packet number to indicate which packet 500 this is in a sequence of packets 500; protocol information for networks that carry multiple types of information to indicate what type of packet 500 is being transmitted, such as data, voice, picture, video; and finally destination and origination information.

Generally, each packet 500 also contains a number of reserve bits 525 located somewhere within the packet 500 to accommodate any future modifications to the network technology that may require the transmission of additional information or instructions with each packet 500 that is currently not transmitted with the packet 500. These reserve bits 525 are typically located in the header 505 and are shown in such location in FIG. 5, but it can be appreciated that the reserve bits 525 may be located anywhere within the packet 500.

Next, the message contains a footer 510 which is information that is placed after the data 515 of the communication. The footer 510 is often referred to as the trailer and generally contains several bits that tell the receiving device that it has reached the end of the packet 500. The footer 510 may also contain some type of error checking code. Finally, the packet 500 contains the payload which is also referred to as the data 515 of the packet 500. The data 515 is the actual data that the packet 500 is delivering to its destination.

Although the packet 500 of data shown in FIG. 5 represents the data 515a-515e of five users, it can be appreciated by one skilled in the art that the packet 500 may carry data for an unlimited number of users. The data 515a-515 for each user may be different in bit length. For example, data for a first user may occupy bits one through ten of data 515a. Data for a second user may occupy bits eleven through eighty of data 515b, and so forth. The instructions to the network equipment as to how the data 515a-515e should be treated is located within the associated portion of the header 505a-505e. As the packet 500 travels through the network, the data 515 contained within the packet 500 for a particular user may be treated differently depending on the information contained within the corresponding portion of the header 505. Thus, if the user has selected the enhanced wireless service, the portion of the header 505a-505e for that particular user reflects the information and the data 515a-515e associated with that user is handled differently by the network equipment. The instructions to the network equipment to handle the data 515a-515e associated with a particular user in a different manner may also be included within the reserve bits 525.

The existing methodology of the wireless service may be adapted or modified to assign additional codes or time slots through a firmware implementation to either one or both of the user's wireless device and the service provider's existing equipment such that each may recognize that the user may be allotted such additional codes or time slots. With regard to the user's wireless device, a user with an older, incompatible device may be required to obtain a new device. Alternatively, the service provider may push the firmware upgrade to its users through its wireless network. For example, a user may receive a notification that a firmware upgrade is available for his or her wireless device and the user may choose whether to receive such upgrade. Still yet alternatively, the user may be required to access a telephone number that provides an automatic upgrade in firmware to increase the capabilities of the user's wireless device and enable the user to select the enhanced service at any time. The upgrade may cause an applet to open when the user later wishes to utilize the enhanced service, as further described herein, or the upgrade may not be visible to the user and future calls are automatically placed using the enhanced service if the user is a subscriber, as further described herein.

In addition to the packets of data that contain the communication, each transmission of a communication contains other packets of data that are coded to generally direct the communication and provide instructions to the equipment as to signaling and other transmission issues. Instructions regarding the transmission of data and the assignment of additional codes or time slots may be included as a data packet that is transmitted during the wireless communication.

The service provider may choose to address each of the possible service issues by providing an all-inclusive enhanced service plan or the wireless service provider may allow the user to select certain individual features or groups of features of the enhanced service. The features may each be offered individually at a lower price than an all-inclusive enhanced service plan. For example, if a user were generally satisfied with the voice quality of his or her communications and was only experiencing an unacceptable amount of dropped or failed communications, the user may want to subscribe to a single feature enhanced service plan that provides a solution to the issue of dropped or failed communications instead of a plan that offers a solution to multiple service issues. In addition, the service provider may provide a subscription service where the user designates certain device numbers for which communications to or from are provided with enhanced service. For example, if the user knows that certain problems are normally encountered during communications to and from a certain device number, the user may want to use the enhanced service only for all outgoing and incoming communications associated with that device number.

Referring to FIG. 3, a user powers on their wireless device at step 100 to begin using the device for either voice or other data communication. The methodology depends on whether the user has subscribed to the enhanced service on a contract basis or whether the user has not entered into any such contract. If the user has subscribed to the enhanced service plan pursuant to a service contract, the user initiates the transmission at step 110 by entering the destination device number of the recipient and pressing the send button, or any other button that causes a communication to be transmitted from the wireless device. Each communication initiated by the user includes the features of the enhanced service to which that user has subscribed. Similarly, each communication received by the user includes the features of the enhanced service.

If the user has not subscribed to an enhanced service plan, the user is presented with options for selecting or declining any or all of the features of the enhanced service at the time of each transmission. The user may choose to decline any further receipt of prompts at any time for selecting the enhanced service at step 130. The user may decline the enhanced service at any time through any type of communication with the service provider including electronic mail, postal mail, telephone, facsimile or by accessing the user's account online through a global electronic network, such as the Internet. If the user has declined to receive any further prompts for the enhanced service, the user does not receive any further messages regarding the ability of the user to elect the enhanced service for the communication. Each communication is placed in accordance with the features of the user's regular service, as subscribed to by the user.

If the user has not subscribed to an enhanced service plan, the user may elect to receive prompts at step 120 to indicate that the enhanced service is available for each communication. The user may decline to select the enhanced service at step 135 for any outgoing or incoming communication. If the user declines to select any or all of the features of the enhanced service at step 135, the user provides the appropriate input to decline the service. The user initiates the transmission of the communication at step 110 in accordance with the features of the user's regular service, as subscribed to by the user.

If the user selects the enhanced service at step 140 and then chooses the particulars of the enhanced service and the method of payment. Specifically, the user provides the appropriate input to choose from an all-inclusive enhanced service at step 141 or a selection of any one of the features of the enhanced service or a combination thereof at step 143. The user may also choose to apply any or all of the features of the enhanced service, such as voice quality and signal strength, at any time during the communication. For example, the selection of an all-inclusive enhanced service at step 141 would cause the transmission of the communication to include each available service enhancement feature. In another example, the user may choose an enhanced service that includes only certain individual features at step 143. The user may want to receive better voice quality, but the user may decline to receive the enhanced service feature for signal strength. These options may be presented to the user in any available manner, such as verbally or through a pop-up applet.

At step 160, the user selects the method of payment for the selected features of the enhanced service selected. The user may choose to pay a monetary value at step 165 for the enhanced service or the user may choose to allot additional plan minutes to the individual communication at step 170. For example, a user of a service contract plan is provided with a fixed number of plan minutes each month. A user's total monthly minutes may vary depending on the type of service contract under which the user has subscribed to service and also the particular service provider. The user pays a fixed amount for these minutes which may be utilized during the peak air time for no additional cost outside of the fixed amount. Once the user utilizes the allotted plan minutes for the month, the user must pay an additional fee per minute. In the case of a user that has a contract plan but is not a subscriber to an enhanced service plan, the user may elect to utilize additional regular allotted plan minutes at step 170 for each communication that is conducted in accordance with the features of an enhanced service. For example, the user may chose to utilize two plan minutes for each minute of the communication. As previously mentioned, the user may also elect to pay an additional fee to use the features of the enhanced service at step 165. This fee may be charged on a per-minute basis or the fee may be a flat fee per communication. Finally, the user initiates the transmission of the communication at step 110.

It is contemplated that a user currently engaging in a communication may request the enhanced service. If the communication is not originally initiated using the enhanced service, the user may perform an action to request the enhanced service at step 180. For example, the wireless device may have a dedicated key to cause the service to be initiated during the communication. Alternatively, the wireless device may have a key that toggles between different functions such as during the communication and when the wireless device is not in use, so long as the user has the ability to depress or otherwise manipulate the key to initiate the service when desired. Thus, if the voice quality fades during the communication, the user may depress the appropriate key to initiate the enhanced service without having to interrupt the communication. The user may also be able to apply the enhanced service in an incremental fashion. For example, if there is a dedicated key on the wireless device, the user may depress the key to apply the enhanced service until the desired quality is received.

Referring to FIG. 4, the process of selecting the enhanced service is described from the perspective of the service provider. Each wireless service provider is assigned a set range of frequencies to use in a particular geographic area, which is further segregated into channels. Although most channels in the assigned range of frequencies are utilized to provide service to wireless users, a number of channels are reserved for use as control channels. The wireless device initially communicates with the telecommunications network to register and gain access to the network. The wireless device first locates the nearest base station at step 300 by listening on a control channel for the system identification code, which is a unique five digit number that is assigned to each wireless service provider by the FCC. The wireless device scans each of the control channels to determine which control channel has the strongest signal. Generally, the closest base station has the strongest signal, and the wireless device communicates with that base station to place the communication. The user causes the wireless device to locate the nearest base station by entering the destination device number of the recipient and pressing the send button or any other button that would transmit information from the wireless device. The device provides the nearest base station with the device number of the device, as assigned to the user, the electronic serial number of the device, which is assigned to the device by the manufacturer and the destination device number of the recipient. Along with this information, the wireless device may also transmit a registration request so that, ultimately, the mobile switching network can keep track of the wireless device in the user register, as described with respect to FIG. 2. This information is forwarded to the mobile switching center at step 305 for validation and access to the wireless network.

Next the mobile switching center scans the user register at step 310 to ensure that the user's account is valid. In addition, the user register is scanned to determine if the user is a subscriber of an enhanced service plan pursuant to a contract at step 315. If the user is a subscriber of an enhanced quality plan pursuant to a service contract, the mobile switching center causes each incoming and outgoing communication to include the features of the enhanced service plan. Specifically, the mobile switching center communicates to the base station at step 370 that the user subscribes to an enhanced service plan, and the base station returns a channel assignment message to the device at step 380 which directs the device to the channel on which the communication will take place.

If the mobile switching center scans the user register at step 315 and determines that the user is not a subscriber of an enhanced service plan, the mobile switching center determines if the user has opted out at step 318. If the user has opted out, the service provider does not prompt the user with regard to any communication, and the communication is placed in accordance with the features of the subscriber's regular plan. Again, the mobile switching center communicates to the base station at step 370 that the user does not subscribe to an enhanced service plan and the user has opted out and should not receive any prompts. The base station returns a channel assignment message to the device at step 380 which directs the device to the channel on which the communication will take place.

If the mobile switching center determines that the user has not opted out at step 318, the mobile switching center may cause the user to be prompted at the initiation of each communication at step 340 to select the enhanced service. Specifically, the mobile switching center transmits a message to the wireless device through the base station prompting the user to select any or all of the features of the enhanced service or to decline the enhanced service at step 340. The message may be in the form of a verbal message or the message may be in the form of a pop-up applet, if the wireless device has such capabilities. The user may choose to decline all of the features of the enhanced service. Accordingly, the communication is placed in accordance with the features of the regular service plan of the user. The mobile switching center communicates to the base station at step 370 that the user has declined the enhanced service. The base station returns a channel assignment message to the device at step 380 which directs the device to the channel on which the communication will take place.

The service provider may prompt the user to select any or all of the features of the enhanced service. As previously described, the service provider may provide the user with the option, such as verbally or through a pop-up applet, of an all inclusive feature enhanced service or the service provider may provide the user with the option to select certain desired features of the enhanced service. Thus, the options provided by the service provider allows the user to select, for example, an enhanced service that provides for better voice quality, but decline to receive enhanced service for fewer dropped calls. This information regarding selected features is transmitted to the mobile switching center through the base station and the user register is updated at step 350.

Next, the service provider may prompt the user to select the method of payment for the enhanced service. The service provider may provide the user with the option to pay a monetary value for the enhanced service or the service provider may provide the option to allot additional plan minutes to the individual communication. When the user selects the method of payment, the information is communicated from the wireless device to the mobile switching station, and the user register is updated at step 360. Finally, the communication is placed in accordance with the features of the selected features of the enhanced service. The mobile switching center communicates to the base station at step 370 any necessary modifications to the transmission of the communication by the user and the base station returns a channel assignment message to the device at step 380 which directs the device to the channel on which the communication will take place.

Referring again to FIG. 2, a user who is enrolled in the enhanced service plan in connection with a service contract is shown at 55. This user is enrolled in an all-inclusive enhanced service plan and receives the benefits of each selected plan feature every time a communication is placed in connection with the wireless device at step 370. A user who is enrolled in a service plan with certain features of the enhanced service is shown at 60. This user is currently receiving only increased signal strength. It is contemplated that this user may or may not receive a prompt at step 340 to select additional enhanced service features, if the user has not opted out of any further prompts. Finally, a user who is not enrolled in any enhanced service plan or feature is shown at 65. Again, depending on whether this user has opted out of any further prompts to select the enhanced service or its individual features, the user shown at 65 may be prompted at step 340 to select such features. All of the data regarding a user's activity in connection with the enhanced service is maintained in the user register to maintain current billing information with regard to the service.

Referring again to FIG. 4, depending on whether the user has selected certain features or the all-inclusive enhanced quality plan, the mobile switching center communicates any necessary information to the base station at step 370. The communication is placed in accordance with the features of the selected enhanced service and the base station sends a channel assignment message to the device which directs the device to the channel on which the conversation will take place.

It is contemplated that a user currently engaging in a communication may request the enhanced service. If the communication is not originally placed using the enhanced service, the user may perform an action to request the service. For example, the wireless device may have a dedicated key to cause the service to initiate during the communication. Alternatively, the wireless device may have a key that toggles between different functions both during the communication and when the wireless device is not in use such that during the communication the user may depress or otherwise manipulate the key to initiate the service. Thus, if the voice quality fades during the communication, the user may depress the appropriate key to initiate the enhanced service without having to divert attention from the communication.

FIG. 5 is an exemplary representation of the communication of information from the wireless device to the mobile switching center. Exemplary user interfaces 205 show the necessary prompts received by the wireless device 210 asking the user to input the required information for using the enhanced service. The wireless device 210 communicates the information through the base station 20 of the cell 15 to the mobile switching center 25 by means of the landline 30, as described in FIG. 1.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of selecting and receiving enhanced wireless service in association with a wireless device, in which a user can select and receive a better quality of wireless service, such as increased voice quality and signal strength, from a service provider in return for an additional cost paid by the user, the method comprising:
subscribing to at least one feature of the enhanced wireless service and
automatically receiving the at least one feature of the enhanced wireless service for each communication associated with the wireless device.

2. A method of selecting and receiving enhanced wireless service in association with a wireless device in which a user can select and receive a better quality of wireless service in connection with a wireless device, such as increased voice quality and signal strength, from a service provider in return for an additional cost paid by the user, the method comprising:
designating at least one device number to receive a communication;
selecting at least one feature of the enhanced service; and
receiving the selected at least one feature of the enhanced service in connection with the communication.

3. The method of selecting and receiving enhanced wireless service of claim 2, wherein the communication is voice.

4. The method of selecting and receiving enhanced wireless service of claim 2, wherein the communication is one of text, video and picture data.

5. The method of selecting and receiving enhanced wireless service of claim 2, further comprising a step of receiving a prompt to select the at least one feature of the enhanced service.

6. The method of selecting and receiving enhanced wireless service of claim 5, wherein the prompt is one of a verbal prompt or an applet.

7. The method of selecting and receiving enhanced wireless service of claim 2, wherein the at least one feature of the enhanced service is selected by depressing a key on the wireless device.

8. The method of selecting and receiving enhanced wireless service of claim 2, further comprising a step of receiving a prompt to select a method of payment for the selected at least one feature of the enhanced service.

9. The method of selecting and receiving enhanced wireless service of claim 8, wherein the method of payment is a monetary value.

10. The method of selecting and receiving enhanced wireless service of claim 8, wherein the method of payment is an allotment of additional airtime minutes to the communication.

11. The method of selecting and receiving enhanced wireless service of claim 2, wherein the enhanced service is selected for an outgoing communication.

12. The method of selecting and receiving enhanced wireless service of claim 2 wherein the enhanced service is selected for an incoming communication.

13. The method of selecting and receiving enhanced wireless service of claim 2, wherein the enhanced service is selected during a communication.

14. The method of selecting and receiving enhanced wireless service of claim 2, wherein the enhanced service is selected by providing a verbal command.

15. The method of selecting and receiving enhanced wireless service of claim 2, wherein the enhanced service is selected by the manipulation of a dedicated key on the wireless device.

16. The method of selecting and receiving enhanced wireless service of claim 2, wherein the enhanced service is selected by the manipulation of a key that toggles between the selection of the enhanced wireless service and at least one other function.

17. The method of selecting and receiving enhanced wireless service of claim 2, wherein the enhanced service is selected by depressing a combination of keys on a keypad of the wireless device.

18. A method of providing enhanced wireless service in association with a wireless device, in which a service provider provides the enhanced service in response to a selection by a user to receive a better quality of wireless service, such as increased voice quality and signal strength, in return for an addition cost paid by the user, the method comprising the steps of:
receiving a communication from a wireless device and
automatically providing at least one feature of the enhanced wireless service for each communication associated with the wireless device.

19. A method of providing enhanced wireless service in association with a wireless device in which a service provider provides the enhanced service in response to a selection by a user to receive a better quality of wireless service, such as increased voice quality and signal strength, in return for an addition cost paid by the user, the method comprising the steps of:
receiving a communication from a wireless device;
verifying the validity of an account associated with the wireless device;
providing a prompt to select at least one feature of the enhanced service;
receiving input from the wireless device in response to the prompt; and
transmitting the communication from the wireless device in association with the input received from the wireless device.

20. The method of providing enhanced wireless service of claim 19, the method further comprising the steps of:
providing a prompt to the wireless device for selecting a method of payment for the selected at least one feature of the enhanced service and
receiving input from the wireless device in response to the prompt.

21. The method of providing enhanced wireless service of claim 19, further comprising the step of regulating the operation of the device in response to the input received from the wireless device.

22. The method of providing enhanced wireless service of claim 21, wherein the device is regulated by increasing the number of bits exchanged between the device and a base station located near the device.

23. The method of providing enhanced wireless service of claim 21, wherein the device is regulated by increasing the number of allocated time slots to the device.

24. The method of providing enhanced wireless service of claim 21, wherein the device is regulated by increasing the bandwidth provided to the device.

25. The method of providing enhanced wireless service of claim 21, wherein the device is regulated by increasing the number of codes provided to the device.
